(19) United States
(12) Patent Application Publication
(10) Pub. No.: US 2025/0219494 A1
(43) Pub. Date: Jul. 3, 2025

(54) AIR BEARING ARRANGEMENT FOR FUEL CELL COMPRESSORS HAVING AN EXPANDER

(71) Applicant: ZF CV Systems Global GmbH, Bern (CH)

(72) Inventors: Janik Ricke, Uetze (DE); Raphael Zwick, Wangen (DE)

(21) Appl. No.: 19/085,758

(22) Filed: Mar. 20, 2025

Related U.S. Application Data
(63) Continuation of application No. PCT/EP2023/074563, filed on Sep. 7, 2023.

(30) Foreign Application Priority Data
Sep. 26, 2022 (DE) 10 2022 124 630.2

(51) Int. Cl. H02K 5/167; B60R 16/033; H01M 8/04111; H02K 7/18

(52) U.S. Cl. CPC H02K 5/1672; B60R 16/033; H01M 8/04111; H02K 7/1823; H01M 2250/20

(57) ABSTRACT

A turbomachine, in particular for a fuel cell system of a vehicle, such as a utility vehicle, has a rotor shaft, an expander wheel fastened on the rotor shaft, and an air bearing arrangement, which is configured to support the rotor shaft rotatably about a rotor axis, wherein a flow path is formed between the expander wheel and the air bearing arrangement. A flow generator is arranged in the flow path between the air bearing arrangement and the expander wheel and configured to generate, depending on a rotation of the rotor shaft, an air flow directed toward the expander wheel, for the purpose of building up a blocking pressure.

### CROSS-REFERENCE TO RELATED APPLICATIONS

This application is a continuation application of international patent application PCT/EP2023/074563, filed Sep. 7, 2023, designating the United States and claiming priority from German application 10 2022 124 630.2, filed Sep. 26, 2022, and the entire content of both applications is incorporated herein by reference.

### TECHNICAL FIELD

The present application relates to a turbomachine, in particular for a fuel cell system of a vehicle, such as a utility vehicle, having a rotor shaft, an expander wheel fastened on the rotor shaft, and an air bearing arrangement, which is configured to support the rotor shaft rotatably about a rotor axis, wherein a flow path is formed between the expander wheel and the air bearing arrangement.

### BACKGROUND

Turbomachines of the type described above are generally known. Air bearing arrangements are preferably used in these turbomachines because they permit contactless mounting of the rotor shaft. The contactless mounting, for its part, requires that between a chamber, in which the expander wheel sits, and the cavity, in which the rotor shaft and at least the rotating parts of the air bearing arrangement are arranged, there is no hermetic closure, but rather the flow path described above is formed.

During the operation of the turbomachine within a fuel cell system, air previously compressed by the turbomachine enters a fuel cell, as a reactant supply for the fuel cell process. After passage through the fuel cell, a lower oxygen reactant mixture, what is referred to as cathode exhaust gas, emerges again from the fuel cell and enters the turbomachine again in order to be expanded in an expander chamber via the expander wheel. The air reaching the expander wheel has a hydrostatic inlet pressure, which is indeed lower than the pressure previously provided by the turbomachine. However, the inlet pressure in the expander chamber is still above the ambient pressure. A positive pressure therefore prevails in the expander chamber surrounding the expander wheel. The cathode exhaust gas contains water in the form of droplets and air saturated with water. While droplet-shaped water can be removed using conventional means, such as water separators, the water bound in the air cannot be easily separated. Water condenses out of the air as a result of the expansion via the expander wheel. Due to the positive pressure in the expander chamber and/or due to capillary action, this condensate may enter the flow path and move toward the air bearing arrangement. This creates inadvertent friction in the bearing and, along with this, potentially a higher rotational resistance, which has to be overcome by the electric machine of the turbomachine. In addition, the wear due to the admission of water increases considerably. These phenomena are undesirable in practice.

### SUMMARY

It is an object of the disclosure to achieve an improvement in a turbomachine of to the effect that the disadvantages described above are overcome as substantially as possible. In particular, it is an object of the disclosure to develop a turbomachine such that improved protection against ingress of water or other contaminants into the air bearing arrangement is achieved without the efficiency of the turbomachine being impaired.

The disclosure, for example, achieves the aforementioned object by proposing a turbomachine including: a rotor shaft; an expander wheel fastened on the rotor shaft; an air bearing arrangement configured to support the rotor shaft rotatably about a rotor axis; wherein a flow path is formed between the expander wheel and the air bearing arrangement; and, a flow generator arranged in the flow path between the air bearing arrangement and the expander wheel and configured to generate, depending on a rotation of the rotor shaft, an air flow directed toward the expander wheel.

In particular, the disclosure proposes that a flow generator is arranged in the flow path between the air bearing arrangement and the expander wheel and is configured to generate, depending on a rotation of the rotor shaft, an air flow directed toward the expander wheel. The disclosure is based on the finding that a greater pressure gradient between the expander wheel and the region of the air bearing arrangement means that there is a greater risk of the ingress of water in the direction of the air bearing arrangement. However, the positive pressure prevailing in the chamber around the expander wheel is higher, the faster the rotor shaft rotates. As a function of the rotor rotational speed, the power of the turbomachine also increases. If the latter has one or more expander stages, this would be the driving power or a recuperation power with which an upstream compressor stage can be supported. In the case of a compressor arrangement, this would also be the compressor power itself. The disclosure therefore proposes also to couple the flow generator to the rotor shaft, specifically in such a way that the flow generator generates a greater air flow in the direction of the expander wheel, the higher the rotational speed of the rotor shaft.

Within the context of the disclosure, a turbomachine should be understood as being both integrally formed compressor expander arrangements, in which one or more compressor stages are operated on a common shaft with the expander wheel, and arrangements, in which the expander wheel is mechanically decoupled in the system from any compressor stages. Both variants are preferred embodiments of the disclosure.

This has the result that, at low rotational speeds, the air flow generated by the flow generator in the direction of the expander wheel is also very low. In this respect, in particular when the turbomachine has one or more compressor stages upstream of the expander stage, the system makes use, however, of the fact that the pressure on the expander wheel always lags behind the compressor-side pressure of the turbomachine by a certain amount of time, since the air compressed by the turbomachine must first pass through other system components, in particular namely the fuel cell, before entering the expander wheel. The fact that the rotor shaft only has to start up at the beginning of the operation of the turbomachine, in order to reach its predetermined operating rotational speed, is therefore not detrimental. As long as the rotational speed is low, there is still no critical positive pressure on the expander wheel. If, after a few seconds, there is a higher positive pressure on the expander wheel, the rotor shaft is, however, already at the required operating rotational speed and the flow generator can provide the necessary flow in the direction of the expander wheel.

In an embodiment, the expander wheel is arranged in an expander chamber into which the cathode exhaust gas is conveyed at a predetermined hydrostatic inlet pressure, wherein the flow generator is configured to build up a blocking pressure on a pressure side facing the expander wheel, which blocking pressure is equal to or greater than the inlet pressure of the expander chamber. This pressure ratio can therefore be readily determined in preliminary tests by calibration, because both the hydrostatic inlet pressure into the expander chamber and the blocking pressure provided by the flow generator directly depend on the rotational speed of the rotor shaft.

In another embodiment, the blocking pressure exceeds the inlet pressure by 0.5 bar absolute or more, preferably by 1.0 bar absolute or more, particularly preferably in a range of 1.0 bar absolute to 2.0 bar absolute, when the rotor shaft reaches or exceeds a predetermined rotational speed.

In various embodiments, the aforementioned predetermined rotational speed is above the lift-off rotational speed of the rotor shaft. The lift-off rotational speed is preferably in a range of 10,000 rpm and 30,000 rpm, preferably between 12,000 rpm and 18,000 rpm.

In another embodiment, the flow generator has a number, preferably a plurality, of recesses and/or projections, which are formed on the rotor shaft. Via the recesses and/or projections, turbulence is achieved by rotation of the rotor shaft, which builds up a dynamic pressure, which can propagate through the flow path in the direction of the expander chamber. In a first variant, the flow generator has a multiplicity of recesses in the form of grooves, which are distributed, preferably uniformly, over the circumference of the rotor shaft. The grooves can, for example, be inserted directly into the surface of the rotor blades, or be applied to a correspondingly configured sleeve on the rotor shaft.

It is also preferred, in various embodiments of the disclosure, for the flow generator to have a plurality of projections distributed, preferably uniformly, over the circumference in the form of ribs, which protrude from the rotor shaft.

In another variant, the rotor shaft has both recesses and projections which are distributed, preferably uniformly, over the circumference of the rotor shaft.

In another embodiment, the recesses and/or projections are aligned parallel to the rotor axis or relative to the rotor axis at an angle.

Preferably, the turbomachine can be configured to rotate the rotor shaft in a preferred direction of rotation, wherein the angle of the recesses and/or projections has a pitch opposed to the direction of rotation. In other words, the recesses and/or projections are aligned rising to the left in a right-rotating rotor shaft and rising to the right in a left-rotating rotor shaft. In this way, the alignment of the flanks of the recesses/projections causes the generation of turbulence which acts in the direction of the expander wheel and with which the blocking pressure can be built up.

The angle preferably lies in a range of 10° to 80° relative to the rotor axis. By this means, in contrast, for example, to spiral grooves, a supporting force acting orthogonally to the rotor axis is applied in the path of the air cushion generation, which has the effect that the recesses and/or projections deploy their action in the axial direction relative to the rotor axis.

In another embodiment, the recesses and/or projections are formed relative to a surface of the rotor shaft and have a radial extent relative to the surface in a range of up to 20 μm. In other words, the radial extent defines the depth of the recesses and/or the height of the projections relative to the surface of the rotor shaft.

The recesses and/or projections may be run rectilinearly along the angle described above, but may also have a curved profile, wherein, in the case of a curved profile, the angle is preferably defined as the angle of a secant which runs between the axial end points of a respective recess or a respective projection.

In a further embodiment, the flow generator is assigned an air supply line, which is provided separately from the air bearing arrangement, wherein the air supply line is preferably configured as a suction line, which is fluid-conductively connected to the environment. The air supply line preferably includes one or more bores, and furthermore preferably a partially or completely circumferentially encircling groove. The air supply line reliably prevents the flow generator from extracting air from the bearing arrangement when the rotor shaft rotates, since the suction side of the flow generator opposite the blocking pressure can be supplied with air via the air supply line.

In another embodiment, the flow generator and the air bearing arrangement are arranged in the direction of the rotor axis adjacent to each other or, preferably, spaced apart from each other, the flow generator being arranged on a side of the air bearing arrangement facing the expander wheel.

The embodiments described above have described the turbomachine with reference to a single flow generator. In another embodiment, however, it is provided that the flow generator is only a first flow generator, and the turbomachine furthermore has a second flow generator, which is arranged relative to the first flow generator opposite the air bearing arrangement, the second flow generator being configured to generate, depending on a rotation of the rotor shaft, an air flow directed away from the air bearing.

The second flow generator is particularly preferably provided for compensating for, or for counteracting, the axial force which is exerted by the first flow generator and acts between the housing of the turbomachine and the rotor shaft. Both flow generators generate a blocking pressure that is directed away from the air bearing arrangement. If the turbomachine on the rotor shaft opposite the expander wheel has a compressor wheel, which it also does in a preferred embodiment, this should be understood as meaning that the second flow generator is configured to build up a blocking pressure in the direction of the compressor wheel.

The operation of the second flow generator is otherwise identical to the operation of the first flow generator.

The embodiments, which refer to the flow generator of the turbomachine and have been described further above, are therefore also embodiments of the second flow generator in the turbomachine.

In an exemplarily embodiment, the second flow generator has a number, preferably a plurality, of recesses and/or projections, which are formed on the rotor shaft.

The recesses and/or projections of the second flow generator can preferably be aligned parallel to the rotor axis or relative to the rotor axis at an angle which is aligned in the opposite direction to the angle of the first flow generator and is preferably equal to the angle of the first flow generator.

In another embodiment, the recesses and/or projections of the second flow generator have a smaller radial extent than the recesses and/or projections of the first flow generator.

### BRIEF DESCRIPTION OF DRAWINGS

The invention will now be described with reference to the drawings wherein:

FIG. 1 shows a schematic illustration of a turbomachine according to a preferred embodiment; and,

FIG. 2 shows a detailed view of the turbomachine according to FIG. 1.

### DETAILED DESCRIPTION

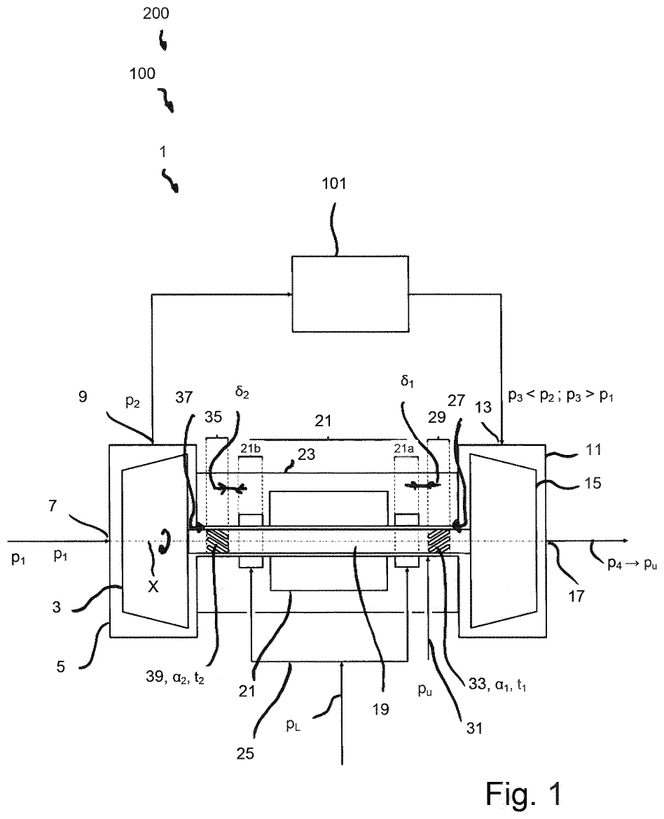

FIG. 1 shows a turbomachine 1, which is part of a fuel cell system 100 of a vehicle 200, preferably a utility vehicle. The turbomachine 1 has a compressor wheel 3, which is arranged in a compressor chamber 5.

The compressor chamber 5 has an inlet 7, which is configured to supply the compressor chamber 5, for example via an intake tract (not shown), with air at an inlet pressure p₁, which is then compressed in the compressor chamber 5 by rotation of the compressor wheel 3 to an outlet pressure p₂ and discharged via an outlet 9 of the compressor chamber 5.

The turbomachine 1 is fluid-conductively connected to a fuel cell 101 of the fuel cell system 100 and configured to use the air compressed by the compressor wheel in a fuel cell reaction in a generally known manner. The air constitutes the cathode-side reactant.

The compressed air is fed to the fuel cell 101 at the pressure p₂.

After passage through the fuel cell 101, an air/water mixture is discharged from the fuel cell 101 as what is referred to as cathode exhaust gas with a hydrostatic pressure p₃, which is lower than p₂. The fuel cell 101 is fluid-conductively connected to an expander chamber 11 of the turbomachine 1, more precisely to an inlet 13 of the expander chamber 11. The expander chamber 11 is assigned to the turbomachine 1 and has an expander wheel 15 in its interior. As a result of the cathode exhaust gas entering with the pressure p₃ as the inlet pressure, the flow is incident on the expander wheel 15 and the cathode exhaust gas is expanded here in a generally known manner such that the cathode exhaust gas leaves the expander chamber 11 through an outlet 17 at a pressure p₄ which is approximately or equal to the ambient pressure p_{U}. The pressure of the cathode exhaust gas p₃ is indeed lower than the pressure p₂ after passage through the compressor chamber 5. However, it is still above the suction pressure p₁, which would be equal to or higher than the ambient pressure p_{U}.

The compressor wheel 3 and the expander wheel 15 are connected via a rotor shaft 19 and are each fastened to the rotor shaft 19 for rotation therewith. The rotor shaft 19 is driven rotatably about a rotor axis X, clockwise in the present embodiment according to FIG. 1, in a generally known manner by an electric machine 21.

The rotor shaft 19 is rotatably mounted in a compressor housing 23 via an air bearing arrangement 21, which is preferably also assigned the expander chamber 11 and the compressor chamber 5.

The air bearing arrangement 21 has at least one first air bearing 21a, which may be a radial air bearing, and a second air bearing 21b, which may likewise be a radial air bearing. Preferably, the air bearing arrangement 21 additionally has one or more axial air bearings (not shown), which also support the rotor shaft 19 and the parts rotating therewith relative to the axis X in the axial direction. For understanding of the air bearing arrangement 21, only the radial air bearings 21a, 21b are shown here.

The air bearing arrangement 21 is fluid-conductively connected for aerostatic support via an air bearing flow path 25 preferably to a compressed air source, which is configured to support the blowing of compressed air at a pressure p into the air bearing arrangement 21, in order to support the load-bearing capacity of the air bearing 21, as long as the rotor shaft 19 has not yet reached its required lift-off rotational speed to form an air cushion of sufficiently load-bearing capacity.

A first flow path 27 is formed between the air bearing 21 and the expander wheel 15 or the expander chamber 11, the flow path being configured as an annular gap between the compressor housing 23 and the rotor shaft 19. This first flow path 27 is ultimately established because of the aim of a contact-free movement of the rotor shaft 19 relative to the compressor housing 23.

The flow path 27 is thus a potential gateway for water and possibly solid-state particles that could penetrate in the direction of the air bearing arrangement 21 because of the positive pressure as a result of the inlet pressure p₃ within the expander chamber 11 and/or as a result of capillary action.

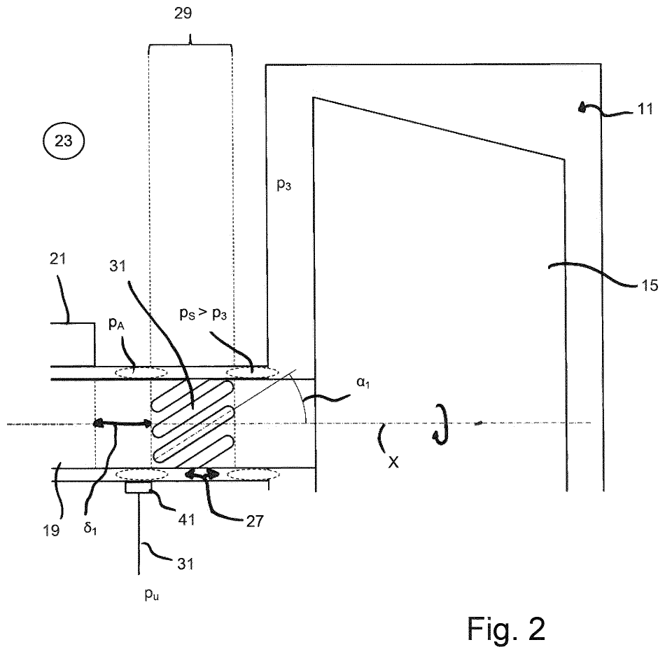

In order to prevent this, a first flow generator 29 is arranged between the air bearing arrangement 21 and the expander chamber 11 or the expander wheel 15, the first flow generator being configured in a manner described further below to build up a blocking pressure p_{S} on its side facing the expander wheel 15 within the flow path 27, depending on the rotational speed of the rotor shaft 19. The flow generator 29 is configured to build up the blocking pressure p_{S} (cf. FIG. 2) at a level of p_{S}>p₃ in order to prevent water droplets and/or particles from being able to move through the flow path 27 as far as the air bearing arrangement 21. Thus, the first flow generator 29 creates a contact-free fluid and particle seal on the basis of the generation of a local positive pressure in the flow path 27 on the side facing from the flow generator 29 to the expander wheel 15.

The first flow generator 29 is furthermore fluid-conductively connected via an air supply line 31. Via the air supply line 31, air can be guided on the suction side of the first flow generator 29, that is, on the side facing the air bearing arrangement 21, as seen from the first flow generator 29, for example from the environment with ambient pressure p_{U}. This effectively prevents bearing air being cannibalized from the air bearing arrangement 21 via the first flow generator 29 by rotation of the rotor shaft 19, and therefore the first flow generator 29 does not impair the load-bearing capacity of the air bearing arrangement 21.

The first flow generator 29 has a number, preferably a plurality, of recesses and/or projections 33, which are provided on the rotor shaft 19 and rotate with the rotor shaft 19 at its rotational speed about the axis X. In the embodiment shown, the recesses and/or projections 33 are configured as grooves which have a predetermined radial extent t₁, namely a depth defining the grooves, and are arranged at an angle α₁ with respect to the rotor axis X. The angle α₁ is aligned rising to the left in relation to the rotor axis X, that is, in the opposite direction to the movement direction of the rotor shaft 19, so that the blocking pressure p_{S} (cf. FIG. 2) is generated on the “correct” side of the flow generator 29.

The turbomachine 1 furthermore, in addition to the first flow generator 29, has a second flow generator 35, which is arranged acting between the air bearing arrangement 21 and the compressor wheel 3, or the compressor chamber 5 in a second flow path 37. The second flow path 37 is likewise configured as an annular gap between the compressor housing 23 and the rotor shaft 19, for the same structural configuration reasons as the first flow path 27.

In basically the same mode of operation as the first flow generator 29, the second flow generator 35 also has a number of projections and/or recesses 39, which are arranged on the rotor shaft 19. The projections and/or recesses 39 are preferably configured as grooves. The projections/recesses 39 have a radial extent t₂, in the case of grooves thus likewise a measure of the groove depth, which is preferably smaller than the radial extent t₁ of the recesses/projections of the first flow generator 29. By differentiating between the radial extents t₁, t₂, a partial compensation of the axial forces generated by the flow generators is achieved, which can also be matched to the axial forces emanating from the compressor wheel 3 or expander wheel 15 in the direction of the axis X.

The alignment of the projections or recesses 39 is carried out in FIG. 1 at an angle α₂, which is aligned in the opposite direction to the angle α₁ of the first flow generator 29, in the case of a right-rotating rotor shaft 19, that is, also rising to the right. Accordingly, the second flow generator 35 generates its blocking pressure on the other side relative to the first flow generator 39, that is, on the side of the flow path 37 facing the compressor wheel 3, or the compressor chamber 5, in order at least to minimize entry of undesired particles also from this side into the flow path 37, and especially also to ensure the abovementioned at least partial compensation of axial force.

In FIG. 2, the right side of the turbomachine 1 according to FIG. 1 is shown on a larger scale. The invention is explained in more detail with respect to the first flow generator 29, wherein the technical functions can be analogously also transferred to the second flow generator 35, the separate illustration of which is omitted here for the sake of clarity.

When the shaft 19 rotates about the axis X in the right-hand direction of rotation, the oppositely directed alignment of the projections or recesses 33 about the angle α₁ on the flank side trailing in the direction of rotation, that is, on the right-hand side in FIG. 2, causes a blocking pressure p_{S} to be built up as a result of the air turbulence in the flow path 27, which blocking pressure, under unobstructed flow conditions, would cause an air flow in the direction of the expander chamber 11. At least, however, the dynamic or blocking pressure p_{S} is generated which, at a sufficiently high rotational speed of the rotor shaft 19, is higher than the hydrostatic inlet pressure p₃ in the expander chamber 11. The blocking pressure p_{S} is preferably 1.0 bar or more higher than the hydrostatic pressure p₃ in the expander chamber 11.

For tracking and/or at least relieving the suction side of the flow generator 29 of load, that side of the flow generator 29 which faces away from the expander wheel 15 is preferably assigned to one or more partially encircling grooves 41, which are fluid-conductively connected to the air supply line 31, in order, via air tracking, to compensate for the locally arising suction negative pressure p_{A}. Preferably, this is carried out with air being sucked in from the environment.

The first flow generator 29 is spaced apart from the air bearing 21 by a distance δ₁ in the direction of axis X. This distance δ₁ to a certain extent creates a neutral zone, in which there are no structural elements on the rotor shaft 19, and preferably also not on the part of the compressor housing 23, in order to minimize mutual interference of the flow generator 29 and the air bearing arrangement 21 as far as possible. Also, a possibly disadvantageous effect of the flow generator 29 or the air turbulence generated by the latter on the air bearing arrangement 21, which could be constructed, for example, as a spiral groove bearing or as a foil bearing, is thus minimized.

Similarly, the second flow generator is preferably spaced apart axially from the air bearing arrangement 21 by a distance δ₂ in the direction of the axis X, see FIG. 1.

It is understood that the foregoing description is that of the preferred embodiments of the invention and that various changes and modifications may be made thereto without departing from the spirit and scope of the invention as defined in the appended claims.

### REFERENCE SIGNS (PART OF THE DESCRIPTION)

1 Turbomachine
5 Compressor chamber
7 Inlet
9 Outlet
11 Expander chamber
15 Expander wheel
17 Outlet
19 Rotor shaft
21 Air bearing
21a, b Air bearing arrangement
23 Compressor housing
25 Air bearing flow path
27 Flow path, on expander side
29 First flow generator
31 Air supply line
33 Projections/recesses, first flow generator
35 Second flow generator
37 Flow path, on compressor side
39 Projections/recesses, second flow generator
100 Fuel cell system
101 Fuel cell
200 Vehicle
X Axis
p₁ Pressure, inlet compressor
p₂ Pressure, outlet compressor
p₃ Inlet pressure expander, cathode exhaust gas
p₄ Outlet pressure expander, cathode exhaust gas
p_{S} Blocking pressure, flow generator
P_{A} Suction pressure, flow generator
p_{U} Ambient pressure
α₁ Angle, first flow generator
α₂ Angle, second flow generator
δ₁ Distance, first flow generator
δ₂ Distance, second flow generator

1. A turbomachine comprising:
a rotor shaft;
an expander wheel fastened on said rotor shaft;
an air bearing arrangement configured to support said rotor shaft rotatably about a rotor axis;
wherein a flow path is formed between said expander wheel and said air bearing arrangement; and,
a flow generator arranged in said flow path between said air bearing arrangement and said expander wheel and configured to generate, depending on a rotation of said rotor shaft, an air flow directed toward said expander wheel.

2. The turbomachine of claim 1, wherein:
said expander wheel is arranged in an expander chamber into which a cathode exhaust gas of a fuel cell is conveyed at a predetermined hydrostatic inlet pressure; and,
said flow generator is configured to build up a blocking pressure on a pressure side facing said expander wheel, wherein said blocking pressure is equal to or greater than said predetermined hydrostatic inlet pressure of said expander chamber.

3. The turbomachine of claim 2, wherein said blocking pressure exceeds the inlet pressure by 0.5 bara or more when said rotor shaft reaches or exceeds a predetermined rotational speed.

4. The turbomachine of claim 1, wherein said flow generator has a number of at least one of recesses and projections, which are formed on said rotor shaft.

5. The turbomachine of claim 4, wherein said at least one of recesses and projections are aligned parallel to the rotor axis or at an angle relative to the rotor axis.

6. The turbomachine of claim 5, wherein the turbomachine is configured to rotate said rotor shaft in a preferred direction of rotation, wherein the angle of said at least one of recesses and projections has a pitch opposed to the preferred direction of rotation.

7. The turbomachine of claim 5, wherein said angle lies in a range of 10° to 80° with respect to the rotor axis.

8. The turbomachine of claim 4, wherein said at least one of recesses and projections are formed relative to a surface of said rotor shaft and have a radial extent relative to the surface in a range of up to 20 μm.

9. The turbomachine of claim 1, wherein said flow generator is assigned an air supply line, which is provided separately from said air bearing arrangement.

10. The turbomachine of claim 1, wherein said flow generator and said air bearing arrangement are arranged in a direction of the rotor axis adjacent to each other or spaced apart from each other by a distance, said flow generator being arranged on a side of said air bearing arrangement facing said expander wheel.

11. The turbomachine of claim 1, wherein said flow generator is a first flow generator; the turbomachine comprises a second flow generator arranged relative to said first flow generator opposite said air bearing arrangement relative to said first flow generator; and, said second flow generator is configured to generate, depending on a rotation of said rotor shaft, an air flow directed away from said air bearing arrangement.

12. The turbomachine of claim 11, wherein said second flow generator has a number of at least one of second recesses and second projections, which are formed on said rotor shaft.

13. The turbomachine of claim 12, wherein said first flow generator has a number of at least one of first recesses and first projections, which are formed on said rotor shaft; said at least one of first recesses and first projections are aligned parallel to the rotor axis or at a first angle relative to the rotor axis; and, said at least one of second recesses and second projections are aligned parallel to the rotor axis or relative to the rotor axis at a second angle which is aligned in an opposite direction to said first angle of said first flow generator.

14. The turbomachine of claim 13, wherein second angle of said second flow generator is equal to said first angle of said first flow generator.

15. The turbomachine of claim 13, wherein said at least one of second recesses and second projections of said second flow generator have a smaller radial extent than said at least one of first recesses and second projections of said first flow generator.

16. The turbomachine of claim 1, wherein the turbomachine is for a fuel cell system of a vehicle.

17. The turbomachine of claim 16, wherein the vehicle is a utility vehicle.

18. The turbomachine of claim 2, wherein said blocking pressure exceeds the inlet pressure by 1.0 bara or more when said rotor shaft reaches or exceeds a predetermined rotational speed.

19. The turbomachine of claim 2, wherein said blocking pressure exceeds the inlet pressure by 1.0 bara to 2.0 bara when said rotor shaft reaches or exceeds a predetermined rotational speed.
